(19) United States
(12) Patent Application Publication
(10) Pub. No.: US 2005/0108434 A1
(43) Pub. Date: May 19, 2005

(54) In-band firewall for an embedded system

(76) Inventor: Nicholas J. Witchey, Laguna Hills, CA (US)

Correspondence Address: KLEIN, O'NEILL & SINGH, 2 PARK PLAZA, SUITE 510, IRVINE, CA, 92614, US

(21) Appl. No.: 10/909,981

(22) Filed: Aug. 3, 2004

Related U.S. Application Data
(63) Continuation-in-part of application No. 10/712,084, filed on Nov. 13, 2003.

(51) Int. Cl. G06F 15/16

(52) U.S. Cl. 709/246

(57) ABSTRACT

A method and embedded system for connecting a legacy device to a network are provided. The system includes a firewall module that can be configured by embedded system firmware to filter data packets when data packets do not match pre-determined rules; determines if data is intended for an allowed port; and discards data if data is not for an allowed port or an allowed address. If address and data port are allowed, then data is transmitted to the network. The method includes, determining if a data packet is from an allowed address, wherein an embedded system coupled to the legacy device uses a firewall module to filter data packets when data packets do not match pre-determined rules; determining if data is intended for an allowed port; and discarding data if data is not for an allowed port or an allowed address.

### CROSS REFERENCE TO RELATED APPLICATION

This patent application is a continuation-in-part of the patent application filed on Nov. 13, 2003, Ser. No. 10/712,084; the disclosure of which is incorporated herein by reference in its entirety.

### BACKGROUND OF THE INVENTION

1. Field of the Invention

The present invention relates to embedded systems, and more particularly, to using a firewall in embedded systems.

2. Background

Computers and computing systems are common in every facet of modern day life. Computing systems come in various forms, for example, desktop computers (PC), handheld devices, laptops, notebooks and embedded systems.

Embedded systems today can be connected to computer networks (for example, the Internet) and to legacy devices that are not necessarily networked enabled. These embedded systems can provide Internet connectivity for various equipment, legacy as well as state of the art. For example, an embedded system allows network/Internet connectivity to vending machines, refrigerators, utility meters, HVAC systems, and home entertainment systems.

Over the last few years many network-enabled products have been globally deployed. As the number of products on the Internet has grown, so have security concerns. Many legacy network-enabled products (referred to as ‘legacy devices”) are not secure against a hostile network.

A hostile network can be characterized in several different ways. A network can be hostile if there are programs, devices, or computers attempting to attack a host through different mechanisms such as ping of death (PoD), denial of service (DoS) attacks, port mapping, and others. In addition, a network can be hostile to a product if the network has a great deal of traffic that the device handles or filters. An embedded system with a low-end CPU does not have enough bandwidth/power to handle a traffic load running at high rate of approximately 10 Mbps to 100 Mbps.

As computing systems are increasingly becoming popular, computer hackers continue to undermine the security of computing systems. One way to protect computing systems is by using a “firewall.”

A firewall is a system that is designed to prevent unauthorized access to or from a private network. Firewalls can be implemented in hardware, software, or a combination of both. Firewalls are frequently used to prevent unauthorized Internet users from accessing private networks connected to the Internet, for example, intranets. All messages entering or leaving the intranet pass through the firewall, which examines each message and blocks those that do not meet the specified security criteria determined by a set of rules created by an information technology manager.

Several types of firewall techniques are known to protect computers and networks, as described below:

“Packet filtering”: This technique examines each packet entering or leaving a network and accepts or rejects it based on user-defined rules. Packet filtering is fairly effective and transparent to users, but it is difficult to configure. In addition, it is susceptible to IP (Internet Protocol) spoofing.

“Application gateway technique” applies security mechanisms to specific applications; such as file transfer protocol (“FTP”) and Telnet servers. Although effective, the technique can cause performance degradation.

“Circuit-level gateway technique” applies security mechanisms when a TCP (Transmission Control Protocol or UDP (User Datagram Protocol) connection is established. Once the connection has been made, packets can flow between the hosts without further checking.

“Proxy server technique” intercepts all messages entering and leaving a network. The proxy server effectively hides the true network addresses and protects the network.

Although firewalls are commonly used with computers, they are designed to protect networks and large arrays of computers. There are no mechanisms to provide protection for embedded systems integrated into a legacy device that directly connects to the Internet. Therefore, there is a need for a system and method that can protect legacy devices from hostile forces and allow dedicated communication between an embedded system and remote system (or remote host) without having to replace or upgrade the legacy device.

### SUMMARY OF THE INVENTION

In one aspect of the present invention, an embedded system for connecting a legacy device to a network is provided. The system includes a firewall module that can be configured by embedded system firmware to filter data packets when data packets do not match pre-determined rules; determines if data is intended for an allowed port; and discards data if data is not for an allowed port or an allowed address. If address and data port are allowed, then data is transmitted to the network.

In another aspect of the present invention, a method for processing data destined to a legacy device coupled to a computer network is provided. The method includes, determining if a data packet is from an allowed address, wherein an embedded system coupled to the legacy device uses a firewall module to filter data packets when data packets do not match pre-determined rules; determining if data is intended for an allowed port; and discarding data if data is not for an allowed port or an allowed address.

This brief summary has been provided so that the nature of the invention may be understood quickly. A more complete understanding of the invention can be obtained by reference to the following detailed description of the preferred embodiments thereof in connection with the attached drawings.

### BRIEF DESCRIPTION OF THE DRAWINGS

The foregoing features and other features of the present invention will now be described. In the drawings, the same components have the same reference numerals. The illustrated embodiment is intended to illustrate, but not to limit the invention. The drawings include the following Figures:

FIG. 1A shows a top-level block diagram showing connectivity between an embedded system, a local device and a remote host;

FIGS. 1B, 2 and 3 show block diagrams of various embodiments that can be used to execute the process steps, according to one aspect of the present invention;

FIG. 4 shows a top-level system architecture for providing a firewall, according to one aspect of the present invention; and

FIGS. 5, 6 and 7 show process flow diagrams for executing process steps using the firewall module, according to one aspect of the present invention.

### DETAILED DESCRIPTION OF THE PREFERRED EMBODIMENTS

In one aspect of the present invention, embedded systems and methods used therewith are provided that incorporate all essential networking features, including a 10Base-T/100Base-TX Ethernet connection, an operating system, an embedded Web server, a full TCP/IP protocol stack and encryption capability for secure communications.

To facilitate an understanding of the preferred embodiment, the general architecture and operation of an embedded system will initially be described. The specific architecture and operation of the preferred embodiment will then be described with reference to the general architecture.

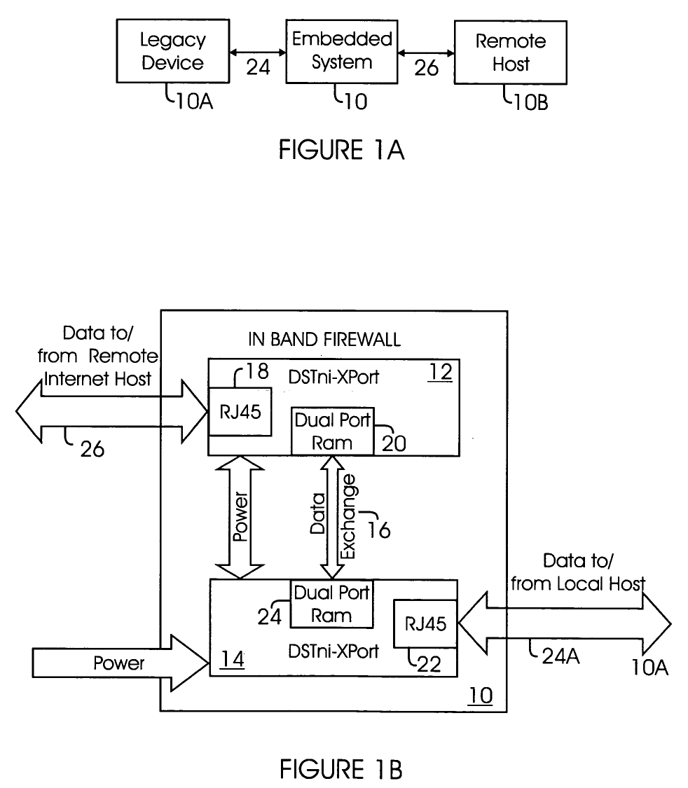

FIG. 1A shows an embodiment of the present invention that allows communication between an embedded system 10, a legacy device 10A and a remote host system 10B. An example of such system 10 is the XPort™ designed and sold by Lantronix Inc.®. Legacy device 10A in this example has limited intelligence, and may include a standalone vending machine, a microwave, a dishwasher or any other device that lacks basic computing ability.

Embedded system 10 receives and sends data 24A to/from local device 10A and remote host 10B. In one aspect, data 26 is transmitted to remote host via the Internet or any other network (for example, local area network and wireless network).

The following provides a brief description of the Internet that may be used to receive and send data using the embedded system 10:

The Internet connects thousands of computers world wide through well-known protocols, for example, Transmission Control Protocol (TCP)/Internet Protocol (IP), into a vast network. Information on the Internet is stored world wide as computer files, mostly written in the Hypertext Mark Up Language (“HTML”). Other mark up languages, e.g., Extensible Markup Language as published by W3C Consortium, Version 1, Second Edition, October 2000, ©W3C may also be used. The collection of all such publicly available computer files is known as the World Wide Web (WWW). The WWW is a multimedia-enabled hypertext system used for navigating the Internet and is made up of hundreds of thousands of web pages with images and text and video files, which can be displayed on a computer monitor. Each web page can have connections to other pages, which may be located on any computer connected to the Internet.

A typical Internet user uses a client program called a “Web Browser” to connect to the Internet. A user can connect to the Internet via a proprietary network, such as America Online or CompuServe, or via an Internet Service Provider, e.g., Earthlink. The web browser may run on any computer connected to the Internet. Currently, various browsers are available of which two prominent browsers are Netscape Navigator and Microsoft Internet Explorer. The Web Browser receives and sends requests to a web server and acquires information from the WWW. A web server is a program that, upon receipt of a request, sends the requested data to the requesting user.

A standard naming convention known as Uniform Resource Locator (“URL”) has been adopted to represent hypermedia links and links to network services. Most files or services can be represented with a URL. URLs enable Web Browsers to go directly to any file held on any WWW server. Information from the WWW is accessed using well-known protocols, including the Hypertext Transport Protocol (“HTTP”), the Wide Area Information Service (“WAIS”) and the File Transport Protocol (“FTP”), over TCP/IP protocol. The transfer format for standard WWW pages is Hypertext Transfer Protocol (HTTP).

FIG. 1B shows a block diagram of embedded system 10. System 10 includes two modular connectors 12 and 14. Connector 12 provides physical connectivity with remote host 10B and includes a RJ-45 jack 18. Connector 14 operationally couples system 10 with local device 10A and includes an RJ-45 jack 22.

Dual port random access memory 20 and 24 is provided to both connectors 12 and 14 to execute process steps, according to one aspect of the present invention. Data 24A is received from local device 10A and is moved to connector 14. Thereafter, data exchange 16 takes place between connector 14 and 12.

In yet another aspect, data 26 is received from a remote host 10B by connector 12. Data 26 is analyzed by a firewall in connector 12 and then transferred to connector 14 via data exchange 16. Thereafter, data 24A is sent to local device 10A.

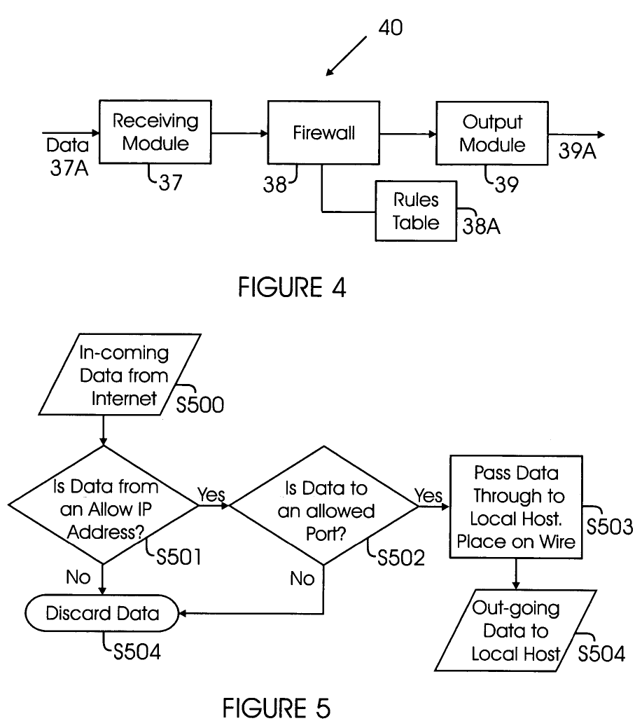

RAM 20 is used to store a table 38A (FIG. 4) with certain rules and firmware code. The rules are used for filtering frames. It is noteworthy that the firmware can enable or disable the use of the firewall rules table 38A,

In one aspect, the process uses a processor in connector 12 and 14, as available in an Ethernet connector described in U.S. patent application Ser. No. 10/122,867 entitled “Compact Serial to Ethernet Conversion Port”, filed on Apr. 15, 2002, the substance of which is incorporated herein by reference. The processor executes the firewall code out of RAM 20.

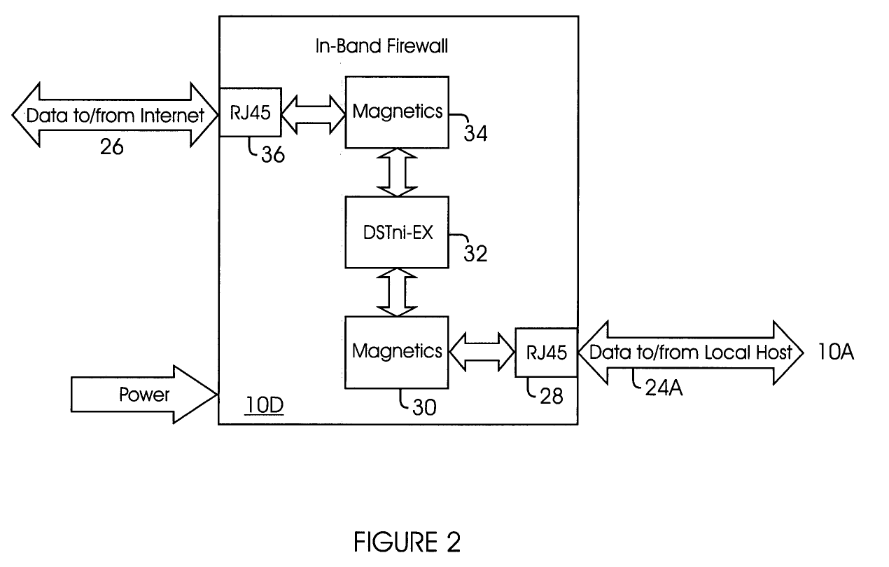

FIG. 2 shows a block diagram of another embodiment 10D that allows data transmission between device 10A and host system 10B via a firewall. System 10D includes a microprocessor 32 for executing the firewall executable steps out of RAM (not shown). An example, of one such processor 32 is DSTni-EX chip as commercially available from Lantronix, Inc. of Irvine, Calif.; however, other processors may be used to execute the process steps. Processor 32 uses embedded executable process steps to analyze data 26, according to one aspect of the present invention. Magnetics 34 and 30 are used to manipulate data signals as received from remote host 10B and device 10A.

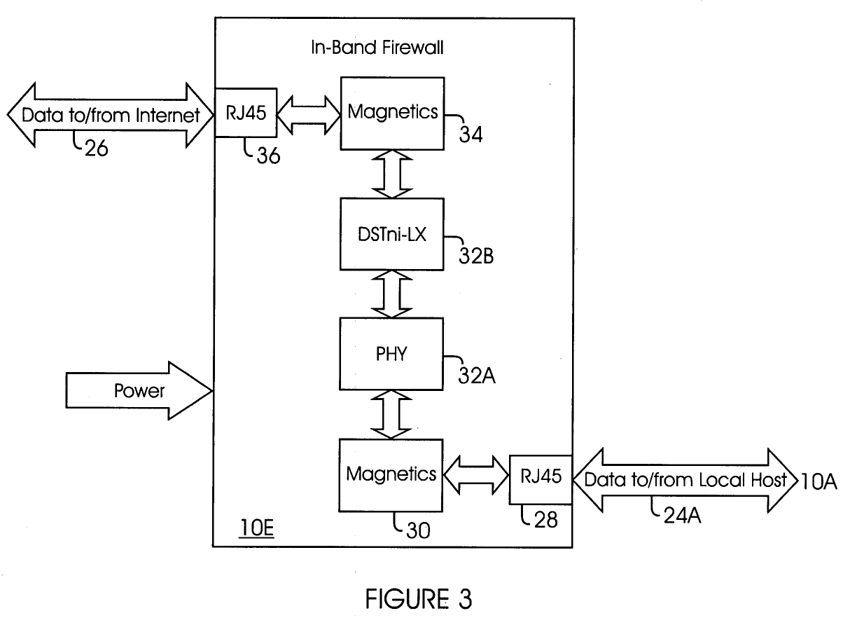

FIG. 3 shows another embodiment for implementing the executable process steps, according to one aspect of the present invention. System 10E is coupled to a network, for example, the Internet using jacks 28 and 36. Data 26 is received from the network (Internet) and analyzed by a firewall executed by processor 32B.

System 10E (similar to embedded system 10) uses a processor DSTni-LX 32B that is commercially available by Lantronix, INC. of Irvine, Calif. A physical interface (PHY) 32A is provided to enable processor 32B for processing input and output signals.

The embodiments shown in FIGS. 1B, 2 and 3 are described in the patent application Ser. No. 10/712,084, filed on Nov. 13, 2003, incorporated herein by reference in its entirety.

FIG. 4 shows a top-level architecture of a system 40 (may also be referred to as an “in-band firewall”) that is used in embedded system 10 according to one aspect of the present invention. System 40 may be modular as shown in FIG. 4 or integrated as a single piece of code. System 40 may be executed out of RAM 20 and/or 24, by processor 32 and/or 32B.

System 40 includes a receiving module 37 that receives input data 37A (for example, data 26 and/or 24A). Processing module (also referred to as “firewall module 38” or “firewall 38”) 38 filters incoming data packets based on the IP address, UDP/TCP port assignments and rules table 38A. Based on the filtering, output module 39 either accepts data packets or discards the packet and then outputs data 39A.

Embedded system 10 with system 40 having firewall module 38 can be plugged directly into an existing network-enabled product and provide network security. Firewall module 38 handles issues associated with a hostile network for legacy device 10A. Firewall module 38 in embedded system 10 can use a male RJ-45 plug (22) that plugs into a female network jack in legacy device 10A; and a female RJ-45 plug (18) where a network cable provides access to the network.

Firewall module 38 appears as a standard network connection; but replicates legacy device 10A's Ethernet MAC address and presents it as the Ethernet address of the female connector. The network then believes that embedded system 10 is the legacy device 10A.

Firewall module 38 contains embedded firmware running a real-time embedded operating system, TCP/IP stack, file system, and application code. The application uses firmware components to monitor the network traffic. As packets are received, the packets are compared to a rules table 38A (for example, in RAM 20) to see if the packet is allowed to be placed on the network. Rules table 38A may be stored in RAM 20 and/or 24. Rules table 38A is dynamic and may be updated remotely. Even though the firewall module 38 can filter outbound traffic, in general, any packet that originates from legacy device 10A is allowed to pass to the network.

Packets from the network (26) entering system 40 are compared to a rules table in firewall module 38. If the packet matches an allowed rule based on an IP address, TCP/UDP ports, and other high level application protocols, the packet is allowed to enter legacy device 10A.

For TCP based communications, firewall module 38 is capable of tracking the state of the connection if necessary. Firewall module 38 may passively pass data without filtering under firmware control. A pass through of packets is needed for some application level protocols such as DHCP (Dynamic Host Control Protocol).

The rules used by the firewall module 38 are input through standard interfaces such as a web browser, Telnet command line, or a file located legacy device 10A. The file can be uploaded through FTP, TFTP, or other mechanism.

Firewall module 38 may be configured to respond to attacks in specific ways. For instance, if there is a DoS attack, then the firewall module 38 logs the IP address of the attack and send an electronic mail to the appropriate personnel or device with the attacker's information such as the IP address of origin.

Firewall module 38 may also be configured to track packet statistics. The statistics may be displayed via a web page and shows the number/details of intrusion information.

It is noteworthy that firewall module 38 may be implemented using hardware/software/firmware or a combination thereof.

FIG. 5 shows a process diagram for executing process steps, according to one aspect of the present invention, for moving data from the Internet using an in-band firewall in the embedded system, according to one aspect of the present invention.

In step S500, data (for example, 26) is received from the Internet.

In step S502, data is analyzed by processing module 38 that determines whether incoming data is from an allowed IP address. If IP address is not allowed, then in step S504, the data is discarded.

If data is from an allowed IP address, then in step S502, processing module determines, if data is intended to an allowed port, for example, device, 10A. If the port is allowed, then data is passed through in step S503 to the local device and then sent in step S504. If the port is not allowed, then in step S504, the data is discarded, as discussed above.

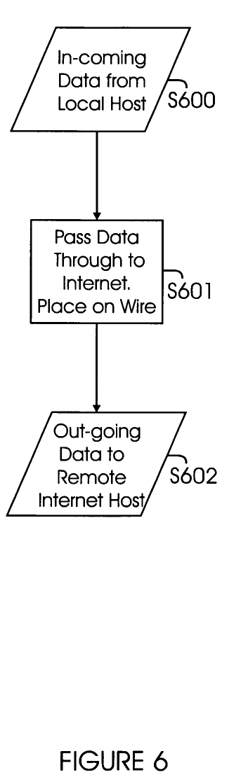

FIG. 6 shows the process flow diagram for data flow from a local device (10A) to a remote host coupled to a network (e.g., the Internet). Turning in detail to FIG. 6, in step S600, data is received from local device 10A. In step S601, processing module 38 determines data is to be passed to the remote host and places the data on the wire (not shown). In step S602, data is sent to remote host 10B.

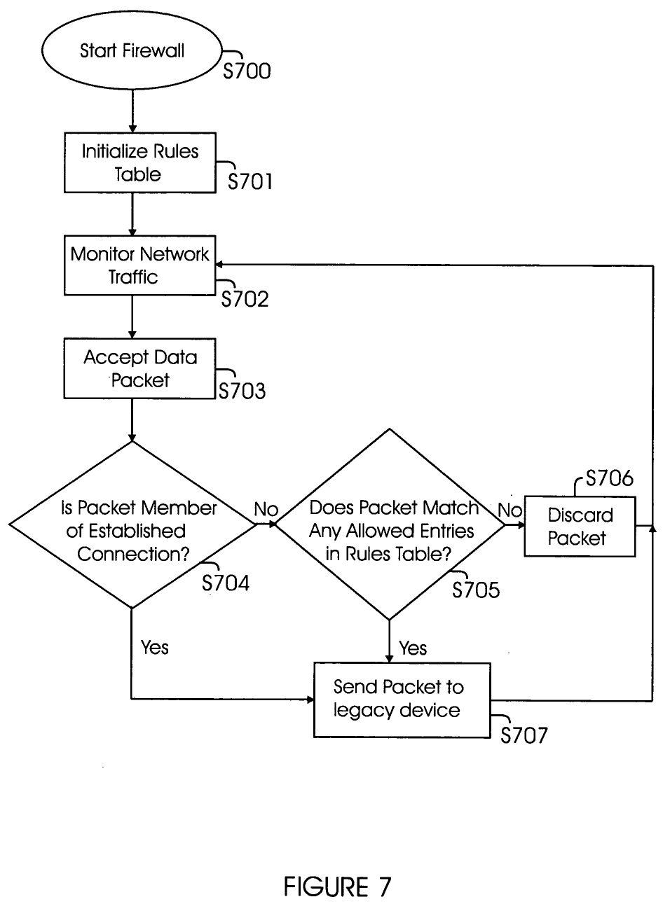

FIG. 7 shows yet another flow diagram for executing process steps for the firewall module 38, according to one aspect of the present invention. In step S700, the firewall is initialized. This occurs when embedded system 10 is started.

In step S701, the rules table 38A is initialized. Thereafter, in step S702, firewall module 38 monitors network traffic (i.e., monitor data 26).

In step S703, a data packet (for example, 26) is accepted from the network.

In step S704, firewall module 38 determines if the packet is for an established connection. If yes, the packet is sent to legacy device 10A.

If the packet in step S704 is not for an established connection, then in step S705, firewall module 38 compares data packet fields with allowed entries in rules table 38A.

If packet entries match the allowed entries in rules table 38A, then the packet is sent to legacy device 10A in step S707, otherwise the packet is discarded in step S706.

In one aspect of the present invention, firewall module 40 restricts communication to a limited number of remote hosts. Since hostile activity directed at the network or device 10A is intercepted by firewall module 38, traffic from unauthorized sources is not allowed to enter legacy device 10A, thereby securing device 10A. Because the embedded system 10 with firewall module 38 handles all network traffic for device 10A, device 10A CPU resources are not wasted and hence optimally utilized.

In another aspect of the present invention, since the firewall 38 is designed to protect a single networked legacy device (device 10A), firewall module 38 does not have to have all traditional firewall capabilities. The firewall does not have to operate as a DHCP server, gateway, NAT system, and load balancing system. Therefore, firewall module 38 does not require as much processing power or memory. Firewall module 38 can be implemented in a cost effective configuration using a low-end embedded CPU and less memory. Cost is further reduced because legacy device 10A does not have to be replaced or upgraded to handle a hostile network.

While the present invention is described above with respect to what is currently considered its preferred embodiments, it is to be understood that the invention is not limited to that described above. To the contrary, the invention is intended to cover various modifications and equivalent arrangements. For instance, instead of two Ethernet interfaces one interface could be a wireless (802.11a/b/g) interface. The firewall 38 then bridges the network as well as provides network protection.

1. A method for processing data destined to a legacy device coupled to a computer network, comprising:
determining if a data packet is from an allowed address, wherein an embedded system coupled to the legacy device uses a firewall module to filter data packets when data packets do not match pre-determined rules;
determining if data is intended for an allowed port; and
discarding data if data is not for an allowed port or an allowed address.

2. The method of claim 1, where if the address and data port are allowed, then data is transmitted to the network.

3. The method of claim 1, wherein the firewall module operates out of a memory module.

4. The method of claim 1, wherein the firewall module provides statistics with intrusion information.

5. An embedded system for connecting a legacy device to a network, comprising:
a firewall module that can be configured by embedded system firmware to filter data packets when data packets do not match pre-determined rules; determines if data is intended for an allowed port; and discards data if data is not for an allowed port or an allowed address.

6. The system of claim 5, where if address and data port are allowed, then data is transmitted to the network.

7. The system of claim 5, wherein the firewall module operates out of a memory module.

8. The system of claim 5, wherein the firewall module provides statistics with intrusion information.

9. The system of claim 5, wherein the firewall module may be configured using rules.

10. A firewall module in an embedded system that is used for connecting a legacy device to a network, comprising:
a rules table used for filtering data packets when data packets do not match pre-determined rules; and the firewall module determines if data is intended for an allowed port;
and discards data if data is not for an allowed port or an allowed address.

11. The firewall module of claim 10, where if address and data port are allowed, then data is transmitted to the network.

12. The firewall module of claim 10, wherein the firewall module operates out of a memory module.

13. The firewall module of claim 10, wherein the firewall module provides statistics with intrusion information.

14. The firewall module of claim 5, wherein the firewall module may be configured remotely.
